(19) United States
(12) Patent Application Publication
(10) Pub. No.: US 2009/0296570 A1
(43) Pub. Date: Dec. 3, 2009

(54) AUTOMATIC SEMI-CROSS CABLE AND SCRAMBLER RESOLUTION MECHANISM FOR 1000BASE-T MASTER/SLAVE DEVICE

(75) Inventors: Daniel Sharon, Givaataim (IL); Ori Isachar, Tel Aviv (IL); Nir Popper, Ramat Hasharon (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 12/129,324

(22) Filed: May 29, 2008

(51) Int. Cl. G06F 11/00

(52) U.S. Cl. 370/225

(57) ABSTRACT

A novel mechanism for 1000BASE-T network adapters to detect and resolve connections for cables that are either fully aligned, fully crossed or semi-crossed. The mechanism is applicable to adapters in either master or slave modes, and operates with cables that either have channels A and B aligned with channels C and D crossed or channels A and B crossed and channels C and D aligned. Cables of different configurations can be switched at any time without impacting network operation. In addition, a mechanism for 1000BASE-T adapters to support multiple scrambling methods between the adapter and its link partner is described.

### FIELD OF THE INVENTION

The present invention relates to the field of data communications and more specifically relates to an automatic cross and semi-cross cable resolution mechanism for a 1000Base-T master/slave device. In addition, the mechanism also establishes a common data scrambling method for the 1000Base-T master and slave devices.

### BACKGROUND OF THE INVENTION

As Ethernet over twisted pair evolved from 10 megabits/second (Mb/s), to 100 megabits/second (Mb/s) to one gigabit/second (Gb/s), network wiring and the physical interface of the Ethernet network adapters changed as well. Both 10BASE-T (10 Mb/s) and 100BASE-T (100Base-T) adapters communicate over the network via two channels (A and B) over two twisted pairs. In both 10BASE-T and 100BASE-T each channel carries data in a single direction. When an adapter is transmitting over channel A and receiving over channel B it is in medium dependant interface (MDI) mode. An adapter transmitting on channel B and receiving on channel A is in (MDI-X) mode.

A block diagram of a prior art example of two coupled network adapters is shown in FIG. 1. The network, generally referenced 10, comprises network devices 12 and 14 communicating over cable 15 comprising twisted pairs 16 and 18. Network device 12 is in MDI mode, transmitting over channel A (via twisted pair 16) and receiving over channel B (via twisted pair 18). The link partner for network device 12 is network device 14. Network device 14 is in MDI-X mode, transmitting over channel B (via twisted pair 18) and receiving over channel A (via twisted pair 16).

The standard for 1000BASE-T is defined by IEEE 802.3 (http://www.ieee802.org/3/). 1000BASE-T devices communicate over a four channels (i.e. twisted pairs) as opposed to the two channels (i.e. two twisted pairs) used by both 100BASE-T and 10BASE-T devices. Additionally, the four channels in a 1000BASE-T cable carry data in both directions simultaneously (as opposed to each channel carrying data in different directions in both 10BASE-T and 100BASE-T cables).

Aside from communicating at the higher 1 Gb/s speed, 802.3 compliant devices are backward compatible with 100BASE-T and 10BASE-T devices. During the initial autonegotiation step, a device and its link partner determine the highest common speed supported by both devices and the connecting cables. The devices then attempt to connect at the highest common speed.

Autonegotiation only uses the first two channels (i.e. A and B) since all supported speeds uses these channels. If autonegotiation establishes a 1 Gb/s link then the remaining channels (i.e. C and D) are used as well. When a 1 Gb/s connection is established, the configuration of channels A and B is defined during autonegotiation, but the configuration of channels C and D is not yet established (their configuration is set when a link is attempted). Since each byte of data sent by a device is split into four channels, the established relationship enables the link partner to reconstruct the data.

Cables connecting 1000BASE-T devices are either fully aligned or fully crossed. A fully aligned cable has each channel on one device coupled to the same channel on its link partner. A block diagram of prior art example of two devices coupled via a fully aligned cable is shown in FIG. 2. The network, generally referenced 20, comprises network devices 22, 24, physical channels 26, 28, 30 32 and logical channels 34, 36, 38, 40, 42, 44, 46, 48. In this configuration device 22 is in MDI-X mode and device 24 is in MDI mode.

When device 22 transmits to device 24, logical channel A 34 transmits to logical channel A 42 on using physical channel B 28, logical channel B 36 transmits to logical channel B 44 using physical channel A 26, logical channel C 38 transmits to logical channel C 46 using physical channel D 32 and logical channel D 40 transmits to logical channel D 48 using physical channel C 30. When device 24 transmits to device 22, logical channel A 42 transmits to logical channel A 34 using physical channel A 26, logical channel B 44 transmits to logical channel B 36 using physical channel B 28, logical channel C 46 transmits to logical channel C 38 using physical channel C 30 and channel D 48 transmits to channel D 40 using physical channel D 32.

A block diagram of prior art example of two devices coupled via a fully crossed cable is shown in FIG. 3. The network, generally referenced 50, comprises network devices 52, 54, physical channels 56, 58, 60 62 and logical channels 64, 66, 68, 70, 72, 74, 76, 78. In this crossed configuration both devices 22 and 24 are in MDI mode.

When device 52 transmits to device 54, logical channel A 64 transmits to logical channel A 72 using physical channel 56, logical channel B 66 transmits to logical channel B 74 using physical channel 58, logical channel C 68 transmits to logical channel C 76 using physical channel 60 and logical channel D 70 transmits to logical channel D 78 using physical channel 62. When device 24 transmits to device 22, logical channel A 72 transmits to logical channel A 64 using physical channel 58, logical channel B 74 transmits to logical channel B 66 using physical channel 56, logical channel C 76 transmits to logical channel C 68 using physical channel C 62 and channel D 78 transmits to channel D 70 using physical channel 60.

In the connecting cables shown in FIGS. 2 and 3 the cables are either fully aligned (FIG. 2) or fully crossed (FIG. 3). The 802.3 standard does not support cables that are semi-crossed, with either channels A and B aligned and channels C and D crossed or channels A and B crossed and channels C and D aligned. In addition signals over an 802.3 network are scrambled. Scrambling a signal smoothes out high and low peaks thereby smoothing the signal, allowing for a more efficient transmission. Additional scrambling algorithms aside from that defined in the standard are not supported.

Therefore, there is a need for a mechanism to automatically resolve 1000BASE-T network cables that are either aligned, fully crossed and semi-crossed. Support for semi-crossed cables should include cables that are aligned on channels A and B and crossed on channels C and D as well as cables that are crossed on channels A and B and aligned on channels C and D. In addition adapters should be able to identify the scrambling method being used by their link partner, provided the scrambling method is in a known universe of scrambling methods.

### SUMMARY OF THE INVENTION

The present invention provides a solution to the prior art problems discussed hereinabove by providing a method for an adapter to detect both the type of cable and the scrambler algorithm used to couple to its link partner. During autonegotiation, the adapter identifies whether channels A and B are aligned or crossed. If a 1 Gb/s link cannot be established with channels C and D then the adapter attempts to establish the link using both different cable configurations (including semi-crossed) and different scrambling algorithms. If the adapter is in slave mode then the adapter toggles between scrambling algorithms before it switches to semi-cross mode and attempts to establish a link. The adapter will also toggle between scrambling methods in semi-cross mode to address all possible cable configurations and scrambler algorithms.

If the adapter is in master mode then the adapter prepares to switch to the crossover state but does not switch due to the limitations of being in master mode. Prior to the next autonegotiation, the adapter is configured to accommodate a different cable configuration or scrambler algorithm (i.e. than was used during the previous autonegotiation).

The present invention also provides a method for establishing a common scrambler between the master and slave devices during the initialization stage when the 1000BASE-T cable coupling the master and slave devices is either fully aligned, fully crossed or semi-crossed. Multiple scrambling methods are supported for fully aligned, fully crossed and semi-crossed cable connections. The mechanism enables the adapter to switch scrambling methods when the adapter is in either master or slave modes.

The present invention is operative to facilitate the design of network adapters that detect cables that are fully aligned, fully crossed or semi-crossed. In addition the adapter will support a number of pre-defined scrambling methods. Cable type and scrambling methods can be changed dynamically, and the adapter will automatically configure to the new environment.

There is thus provided in accordance with the invention a method to detect and resolve a semi-crossed cable linking an MDI/MDI-X networking adapter and its link partner, the method comprising the step of detecting link failures in both fully aligned and fully crossed states of said link and establishing a link with said link partner via said semi-crossed cable implementing a semi-crossed state.

There is also provided in accordance with the invention a method to detect and resolve a semi-crossed cable between an MDI/MDI-X networking adapter and its link partner, channels A and B of said MDI/MDI-X networking adapter operating in an aligned state and said adapter utilizing a scrambling method, the method comprising the steps of identifying the Ethernet PHY mode of said MDI/MDI-X networking adapter, determining a common scrambling method utilized by said MDI/MDI-X networking adapter and said link partner and crossing channels C and D in response to a link failure thereby enabling said MDI/MDI-X networking adapter operating in MDI mode to successfully link to its link partner.

There is further provided in accordance with the invention a method to detect and resolve a semi-crossed cable between an MDI/MDI-X networking adapter and its link partner, channels A and B of said MDI/MDI-X networking adapter operating in a crossed state and said adapter utilizing a scrambling method, the method comprising the steps of identifying the Ethernet PHY mode of said MDI/MDI-X networking adapter, determining a common scrambling method utilized by said MDI/MDI-X networking adapter and its link partner and aligning channels C and D in response to a link failure, thereby enabling said MDI/MDI-X networking adapter operating in MDI-X state to successfully link to its link partner.

There is also provided in accordance with the invention an MDI/MDI-X networking adapter capable of detecting and resolving a semi-crossed cable between said MDI/MDI-X networking adapter and its link partner, channels A and B of said MDI/MDI-X networking adapter operating in an aligned state and with said adapter utilizing a scrambling method, the adapter comprising means for identifying the Ethernet PHY mode of said MDI/MDI-X networking adapter, means for determining the common scrambling method utilized by said MDI/MDI-X networking adapter and said link partner and means for crossing channels C and D in response to a link failure thereby enabling said MDI/MDI-X networking adapter operating in MDI mode to successfully link to its link partner.

There is further provided in accordance with the invention an MDI/MDI-X networking adapter capable of detecting and resolving semi-crossed cables between said MDI/MDI-X networking adapter and its link partner, channels A and B of said MDI/MDI-X networking adapter operating in a crossed state and with said adapter utilizing a scrambling method, the adapter comprising: means for identifying the Ethernet PHY mode of said MDI/MDI-X networking adapter, means for determining the common scrambling method utilized by said MDI/MDI-X networking adapter and said link partner and means for aligning channels C and D in response to a link failure, thereby enabling said MDI/MDI-X networking adapter operating in MDI-X state to successfully link to its link partner.

### BRIEF DESCRIPTION OF THE DRAWINGS

The invention is herein described, by way of example only, with reference to the accompanying drawings, wherein:

FIG. 1 is an diagram of an example prior art implementation of two network adapters coupled in a MDI/MDI-X configuration;

FIG. 2 is an diagram of an example prior art implementation of two 1000BASE-T network adapters coupled via a fully aligned cable;

FIG. 3 is an diagram of an example prior art implementation of two 1000BASE-T network adapters coupled via a fully crossed cable;

FIG. 4 is a state diagram illustrating the automatic cross and semi-cross resolution method of the present invention;

FIG. 5 is a diagram of an example of two 1000BASE-T network adapters coupled via a semi-crossed cable where channels A and B are crossed and channels C and D are aligned, illustrating the automatic cross and semi-cross resolution method of the present invention;

FIG. 6 is a diagram of an of two 1000BASE-T network adapters coupled via a semi-crossed cable where channels A and B are aligned and channels C and D are crossed, illustrating the automatic cross and semi-cross resolution method of the present invention;

FIG. 7 is a pseudo-code listing illustrating a sample implementation of a scrambler counter for the automatic cross and semi-cross resolution method of the present invention;

FIG. 8 is a block diagram of a communications transceiver implementing the automatic cross and semi-cross cable resolution with multiple scrambling algorithms mechanism of the present invention; and

FIGS. 9A, 9B and 9C are a flow diagram illustrating the automatic cross and semi-cross cable resolution with multiple scrambling algorithms method of the present invention.

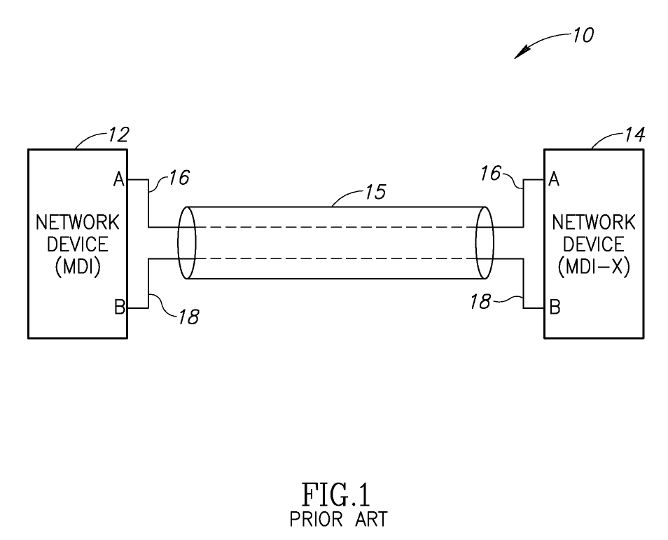

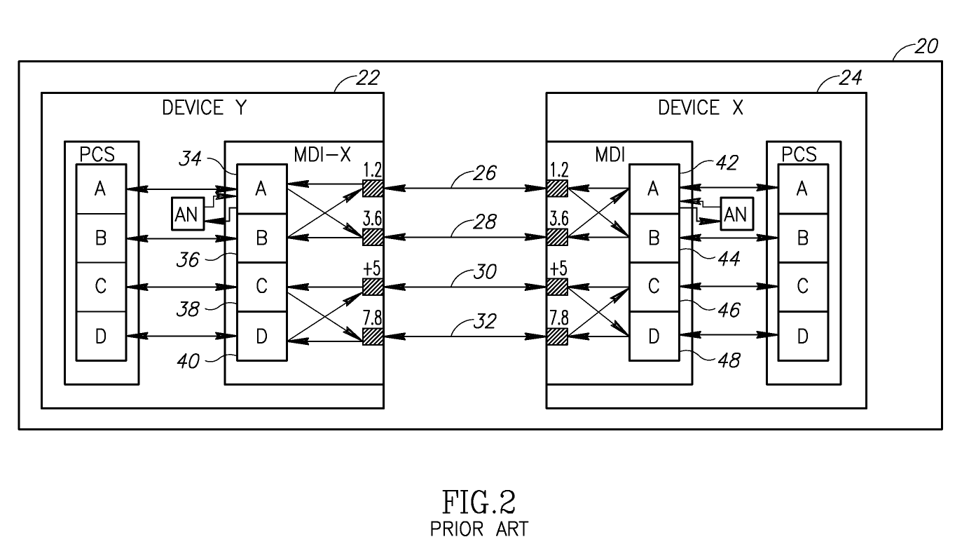

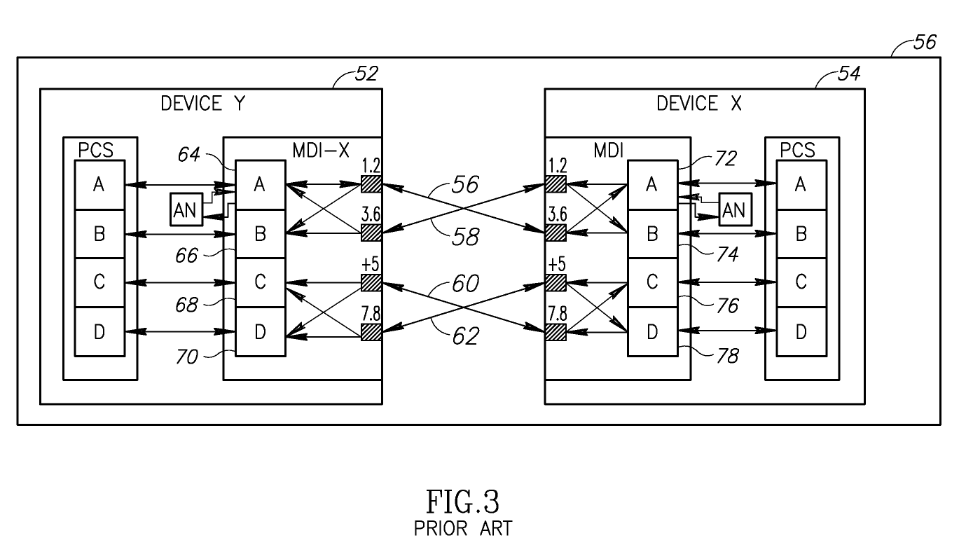

### DETAILED DESCRIPTION OF THE INVENTION

### Notation Used Throughout

The following notation is used throughout this document.

| Term | Definition |
|---|---|
| Gb/s | Gigabits/Second |
| HCD | Highest Common Denominator |
| Mb/s | Megabits/Second |
| MDI | Media Dependant Interface |
| MDI-X | Media Dependant Interface Crossover |
| PCS | Physical Coding Sublayer |
| PLL | Phase Lock Loop |
| RX | Receive |
| SGMII | Serial Gigabit Media Independent Interface |
| SMI | Structure of Management Information |
| TX | Transmit |

### DETAILED DESCRIPTION OF THE INVENTION

The present invention provides a solution to the prior art problems discussed hereinabove by providing a method for an adapter to detect both the type of cable and the scrambler algorithm used to couple to its link partner. During autonegotiation, the adapter identifies whether channels A and B are aligned or crossed. If a 1 Gb/s link cannot be established with channels C and D then the adapter attempts to establish the link using both different cable configurations (including semi-crossed) and different scrambling algorithms. If the adapter is in slave mode then the adapter toggles between scrambling algorithms before it switches to semi-cross mode and attempts to establish a link. The adapter will also toggle between scrambling methods in semi-cross mode to address all possible cable configurations and scrambler algorithms.

If the adapter is in master mode then the adapter prepares to switch to the crossover state but does not switch due to the limitations of being in master mode. Prior to the next autonegotiation, the adapter is configured to accommodate a different cable configuration or scrambler algorithm (i.e. than was used during the previous autonegotiation).

The present invention is operative to facilitate the design of network adapters that detect cables that are fully aligned, fully crossed or semi-crossed. In addition the adapter will support a number of pre-defined scrambling methods. Cable type and scrambling methods can be changed dynamically, and the adapter will automatically configure to the new environment.

### Automatic Cross and Semi-Cross Cable Resolution

As discussed supra, the mechanism of the present invention provides a method to detect and accommodate fully aligned, fully crossed and semi-crossed cables while the adapter is in either master or slave mode. If autonegotiation complete with the adapter in slave mode and a link cannot be established, then the adapter dynamically switches to a state to accommodate a semi-crossed cable. Dynamically switching states is not possible during autonegotiation when the device in master mode and a link cannot be established. This is due to the fact that when the adapter is in master mode it (i.e. the adapter in master mode) is controlling the timing between the master and the slave. Since an adapter in master mode cannot change its configuration dynamically, it changes its configuration after autonegotiation is restarted.

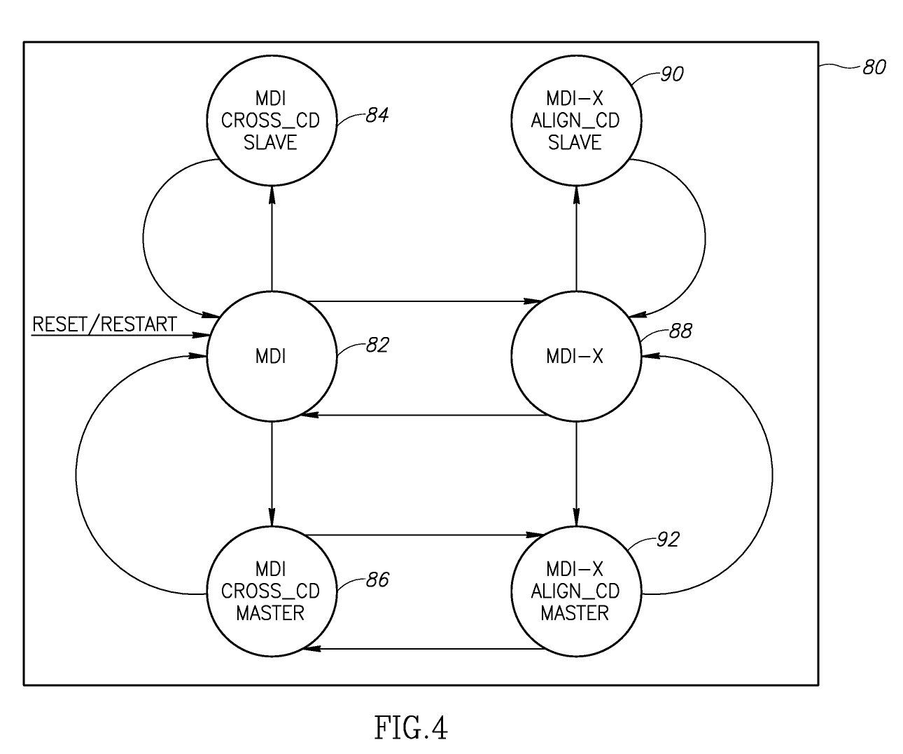

A state diagram showing the automatic cross and semi-cross resolution of the present invention is shown in FIG. 4. The auto-crossover machine, generally referenced 80, comprises MD state 82, MDI CROSS_CD SLAVE state 84, MDI CROSS_CD MASTER state 86, MDI-X state 88, MDI-X ALIGN_CD SLAVE 90, MDI-X_ALIGN_CD MASTER state 92 and reset/restart entry point 94.

During Auto-Negotiation, the auto-crossover machine toggles between states 82 and 88 until it identifies its link partner on either channels A or B. Once a signal is identified, auto-crossover machine 80 remains in its current state (i.e. either MDI 82 or MDI-X 88). The transmit and receive path multiplexers are both changed every time the auto-crossover machine switches to a new state. Note that during autonegotiation only pairs A and B are used. Therefore, the configuration of pairs C and D are not established at that stage. In MDI/MDI-X states 82 and 88 the configuration is changed for all pairs (i.e. A, B, C and D).

The MDI CROSS_CD SLAVE 84 and MDI-X ALIGN_CD SLAVE 90 states are used to support semi-crossed cables either where pairs A and B are aligned and pairs C and D are crossed or where pairs A and B are crossed and pairs C and D are aligned. These states are used after autonegotiation has completed successfully and during the 1 Gb/s link establishment period, where the local device is configured as slave. After autonegotiation, the appropriate configuration of channels A and B is resolved. If the 1 Gb/s physical coding sublayer (PCS) is unable to synchronize during the link establishment period, it might be due to a semi-cross cable configuration. The next step is to try to change the MDI/MDI-X multiplexer of channels C and D only (while leaving the configuration of channels A and B as is).

The reasons that trigger transitions in the state diagram are as follows: Transitioning from MDI (82) to MDI-X (88) occurs when
No Signal Received AND
Not Transmitting AND
State Transition Timer Expired.
   Transitioning from MDI-X (88) to MDI (82) occurs when:
No Signal Received AND
Not Transmitting AND
(State Transition Timer Expired OR Return to Initial State Timer Expired).

Transitioning from MDI (82) to MDI CROSS_CD SLAVE (84) occurs when
Local Device is a 1 Gb/s Slave AND
PCS Sync Fail.
   A PCS Sync Fail event will occur when the adapter is in slave mode after failing to link using all possible scrambler algorithms. Transitioning from MDI CROSS_CD SLAVE (84) to MDI (82) occurs when
Link Dropped OR
Restart by Auto-Negotiation OR
PCS Sync Fail.

Transitioning from MDI (82) to MDI CROSS_CD MASTER (86) occurs when
Local Device is a 1 Gb/s Master AND
Restart by Auto-Negotiation AND
Master Semi-Cross Resolution Enabled.
   Transitioning from MDI CROSS_CD MASTER (86) to MDI (82) occurs when
(Local Device is a 1 Gb/s Master AND Restart by Auto-Negotiation) OR
Local Device is a 1 Gb/s Slave OR
Negotiated Speed Not 1 Gb/s.

Transitioning from MDI (82) to MDI-X ALIGN_CD SLAVE (86) occurs when
Local Device is a 1 Gb/s Master AND
Restart by Auto-Negotiation AND
Master Semi-Cross Resolution Enabled.
   Transitioning from MDI-X ALIGN_CD SLAVE (86) to MDI (82) occurs when
(Local Device is a 1 Gb/s Master AND Restart by Auto-Negotiation) OR
Local Device is a 1 Gb/s Slave OR
Negotiated Speed Not 1 Gb/s.

Transitioning from MDI-X (88) to MDI-X_ALIGN_CD MASTER (92) occurs when
Local Device is a 1 Gb/s Master AND
Restart by Auto-Negotiation AND
Master Semi-Cross Resolution Enabled.
   Transitioning from MDI-X ALIGN_CD MASTER (92) to MDI-X (88) occurs when
(Local Device is a 1 Gb/s Master AND Restart by Auto-Negotiation) OR
Local Device is a 1 Gb/s Slave OR
Negotiated Speed Not 1 Gb/s.

Transitioning from MDI CROSS_CD MASTER (86) to MDI-X ALIGN_CD MASTER (92) occurs when
No Signal Received AND
Not Transmitting AND
State Transition Timer Expired.
   Transitioning from MDI-X ALIGN_CD MASTER (92) to MDI CROSS_CD MASTER (86) occurs when
No Signal Received AND
Not Transmitting AND
(State Transition Timer Expired OR
Return to Initial State Timer Expired).

As an illustrative example, assume that Auto-Negotiation has completed and that the auto-crossover machine is in the MDI-X state 88. Since the 1 Gb/s PCS cannot synchronize, it therefore sends a pulse PCS Sync Fail. The auto-crossover machine then switches to the MDI-X ALIGN_CD SLAVE state 90. The multiplexers for channels C and D (for both transmit and receive paths) are changed and the PCS will attempt synchronization again. The auto-crossover machine toggles between these two states (i.e. states 88 and 90) until the link is established or autonegotiation is restarted (due to expiry of the internal timer). If autonegotiation is restarted (due to either an expiry of the internal timer or a Link Establishment Failed), the auto-crossover machine 80 returns from the MDI-X ALIGN_CD SLAVE state 90 back to the MDI-X state 88.

MDI CROSS_CD MASTER state 86 and MDI-X ALIGN_CD MASTER state 92 are used to resolve semi-cross configuration in master mode. The key difference between semi-cross resolution in slave and master modes is that the master transmits first and the slave then resolves its own MDI/MDI-X configuration (i.e. of channels C and D since the configuration of channels A and B are known) according to the master configuration. Therefore, the master MDI/MDI-X configuration is not changed after autonegotiation completes since the slave should be able to resolve accordingly. The problem arises is a device is not able to detect semi-cross configuration and may not establish a link if the cable is semi-crossed. Therefore, the semi-cross configuration in master mode is determined in the beginning of autonegotiation and only changed the next time autonegotiation starts.

For example, autonegotiation starts with auto-crossover machine 80 in MDI state 82. Autonegotiation completes with the local device configured as 1 Gb/s master and auto-crossover machine 80 is in the MDI-X state 88. The two devices, however, fail to establish a link. The local device switches to the MDI-X ALIGN_CD MASTER state 92 on expiry of the internal timer and autonegotiation restarts, this time with the C and D pair configuration preset to be the opposite of the earlier configuration.

Since autonegotiation restarted, the initial MDI/MDI-X configuration (of pairs A and B) need to be resolved again. Auto-crossover machine 80 will first toggle between MDI state 82 and MDI-X state 88 before it is able to transition to another (i.e. the appropriate) state. The transitions between the MDI CROSS_CD MASTER state 86 and the MDI-X ALIGN_CD MASTER state 92 are the same as in the MDI/MDI-X states, with the only difference being that once autonegotiation completes, the transmission in pairs C and D is already set to semi-cross. If autonegotiation completes with the auto-crossover machine 80 in one of the master states (i.e. states 86 or 92) and the new highest common denominator (HCD) is not 1 Gb/s, or the local device is not the master, the auto-crossover machine returns to the appropriate non-master MDI/MDI-X state, since the master states are used only for 1 Gb/s master configurations. In the case where the local device is now slave, then it will return to toggling between MDI (82) and MDI-X (88) states since it cannot shift directly from a master state to a slave state. Switching from a master to a slave state is accomplished by restarting autonegotiation since the master/slave configuration is determined by auto-negotiation (and also since autonegotiation cannot be performed when the auto-crossover machine is in one of the slave states).

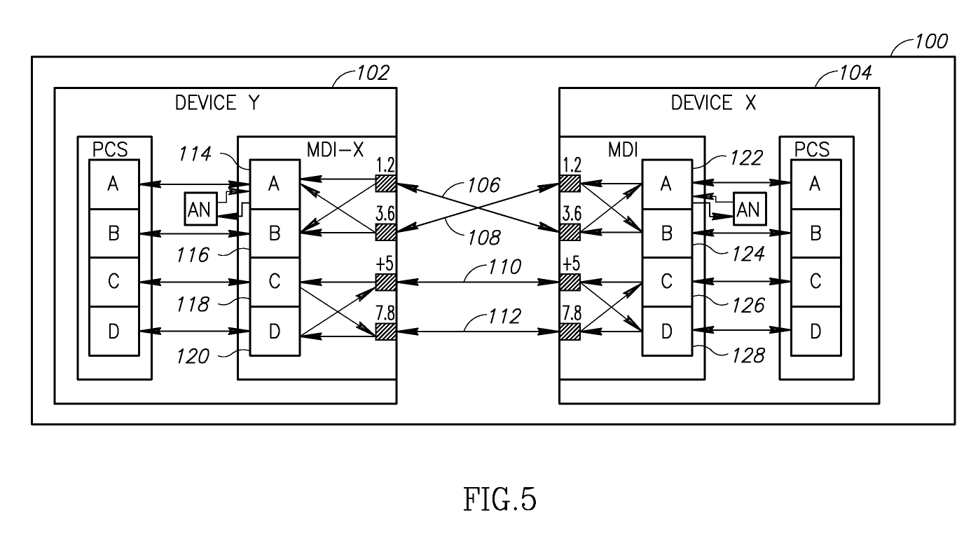

A block diagram of two devices coupled via a cable crossed on channels A and B and aligned on channels C and D is shown in FIG. 5. The network, generally referenced 100, comprises network devices 102, 104, physical channels 106, 108, 110, 112 and logical channels 114, 116, 118, 120, 122, 124, 126, 128. In this configuration, device 104 is in MDI mode and device 102 is in MDI-Crossed CD mode.

When device 102 transmits to device 104, logical channel A 114 transmits to logical channel A 122 using physical channel 106, logical channel B 116 transmits to logical channel B 124 using physical channel 108, logical channel C 118 transmits to logical channel C 126 using physical channel 112 and logical channel D 120 transmits to logical channel D 128 using physical channel 110. When device 104 transmits to device 102, logical channel A 122 transmits to logical channel A 114 using physical channel 108, logical channel B 124 transmits to logical channel B 116 using physical channel 106, logical channel C 126 transmits to logical channel C 118 using physical channel 110 and channel D 128 transmits to channel D 120 using physical channel D 112.

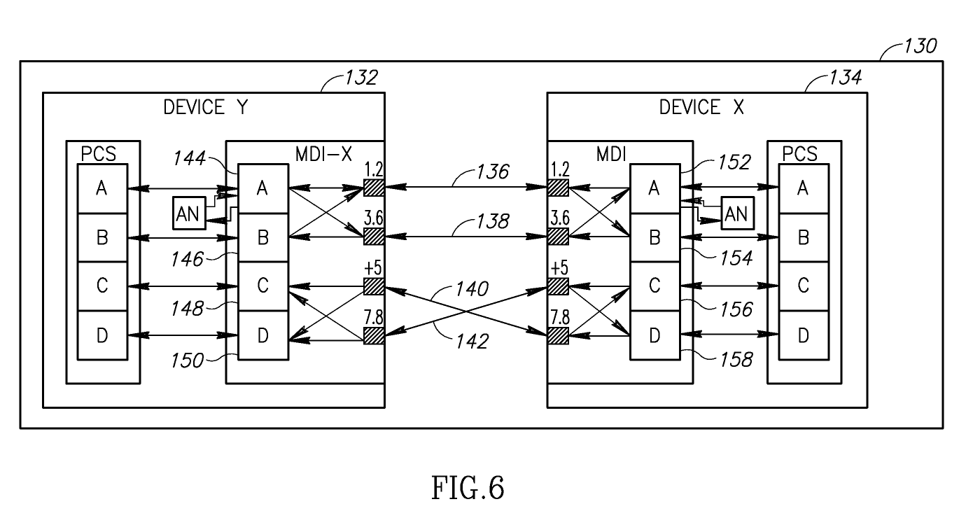

A block diagram of two devices coupled via a cable aligned on channels A and B and crossed on channels C and D is shown in FIG. 6. The network, generally referenced 130, comprises network devices 132, 134, physical channels 136, 138, 140 142 and logical channels 144, 146, 148, 150, 152, 154, 156, 158. In this crossed configuration, device 134 is in MDI mode and device 132 is in MDI-X Align CD mode.

When device 132 transmits to device 134, logical channel A 144 transmits to logical channel A 152 using physical channel 138, logical channel B 146 transmits to logical channel B 154 using physical channel 136, logical channel C 148 transmits to logical channel C 156 using physical channel 140 and logical channel D 150 transmits to logical channel D 158 using physical channel 142. When device 134 transmits to device 132, logical channel A 152 transmits to logical channel A 144 using physical channel 136, logical channel B 154 transmits to logical channel B 146 using physical channel 138, logical channel C 156 transmits to logical channel C 148 using physical channel C 142 and channel D 158 transmits to channel D 150 using physical channel 140.

### Scrambling Method Resolution

In addition to resolving the semi-cross configuration in 1 Gb/s master and slave modes, the present invention provides a mechanism for the PCS to determine which scrambling method to use before transmission begins. Similar to switching cable configuration in master mode discussed supra, the scrambling method is also not changed in master mode after autonegotiation.

Consider a local device being a master in 1 Gb/s mode after autonegotiation and a link not being established. This may be caused by (1) the cable being semi-crossed and the slave cannot resolve the semi-cross, (2) the slave being able to only receive data encoded by a specific scrambling method, (3) both of the above or (4) none of the above. If the reason for the link failure is one of the first three reasons described above, the auto-crossover machine together with a scrambling method counter should eventually transmit in the correct configuration for the problematic slave and establish a link.

The scrambling method counter is a counter that increments every time the local device is 1 G master and the expiry of the internal timer without successfully establishing a link. Depending on the value stored in the scrambling method counter, the transmission mode is set to use the next available scrambling method.

For example, if two scrambling methods are available then a two-bit counter is used. The scrambling method is changed when the most significant bit in the counter changes. In this case, four consecutive 1 Gb/s link establishment failures when the device is in master mode (i.e. the device remains in master mode during four consecutive autonegotiations) cover all four possible master semi-cross and scrambling method transmission modes. This example (i.e. using two scrambling methods with the PCS in master mode) can be further illustrated using the MDI-X state machine discussed supra. Since the scrambler counter is only applicable when the device is in master mode, the scrambler counter is reset when the device exits autonegotiation in slave mode.

The example of a scrambler counter implemented by a two bit counter allows for two scrambling methods for both MDI master and MDI-X master modes (i.e., four total combinations). In this implementation the scrambler counter would reset to zero (i.e. binary “00”) if the scrambler counter was incremented when the scrambler counter value was three (i.e. binary “11”).

When autonegotiation completes for the first time, the device is in 1 Gb/s master mode, the MDI-X state is in MDI state 82, transmission mode MDI and the first scrambling method is used. If the link fails due an expiry of the internal timer, the auto-crossover machine switches to the state MDI_CROSS_CD_MASTER 86 and the scrambling method counter is incremented. Autonegotiation completes a second time with the device (again) in 1 Gb/s master mode, transmission mode MDI with crossed CD Normal and still using the first scrambling method.

If the link fails a second time due an expiry of the internal timer, the auto-crossover machine returns to MDI state 82, incrementing the scrambling method counter (this time changing the most significant bit). Autonegotiation completes with the device (again) in 1 Gb/s master mode, transmission mode MDI, but this time the scrambling method changes to the second method. If the link fails a third time due an expiry of the internal timer, the auto-crossover machine switches to the MDI_CROSS_CD_MASTER state 82, incrementing the scrambling method counter. Autonegotiation completes with the device (again) in 1 Gb/s master mode, transmission mode MDI with crossed CD, using the second scrambling method.

When different scrambler algorithms are implemented in auto-crossover machine 80, the process of switching scrambler algorithms depends on whether the auto-crossover machine is master or slave. If the auto-crossover machine is slave, then the scrambling algorithm can be changed within the same state (i.e. either MDI CROSS_CD SLAVE or MDI-X ALIGN_CD SLAVE). At this point the device is receiving data. When the device is in slave mode it will not transmit data until both the cable configuration is correct and scrambling method is known.

Switching scrambling algorithms in the automatic cross and semi-cross resolution method of the present invention when the adapter is master is accomplished via a scrambler counter. The scrambler counter enables the semi-cross machine to keep track of scrambler algorithms in order to ensure that a different scrambler algorithm is implemented after an autonegotiation (since autonegotiation is required to switch states when the adapter is master).

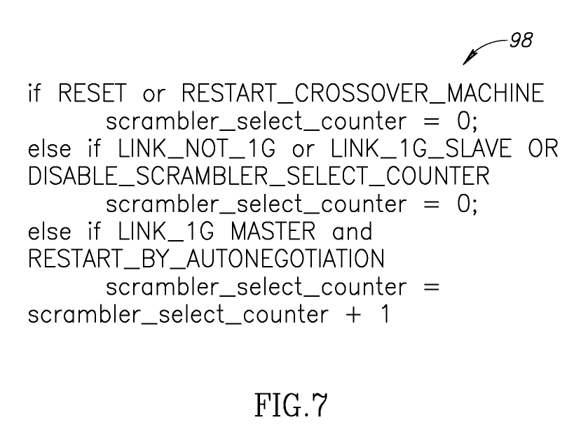

A pseudo-code listing illustrating a software implementation of a scrambler counter is shown in FIG. 7. The code listing generally referenced 98 indicates that the scrambler counter is incremented only when there is a RESTART_BY_AUTONEGOTIATION. The scrambler counter is reset if either the auto-crossover machine is in slave mode or the auto-crossover machine is reset/restarted.

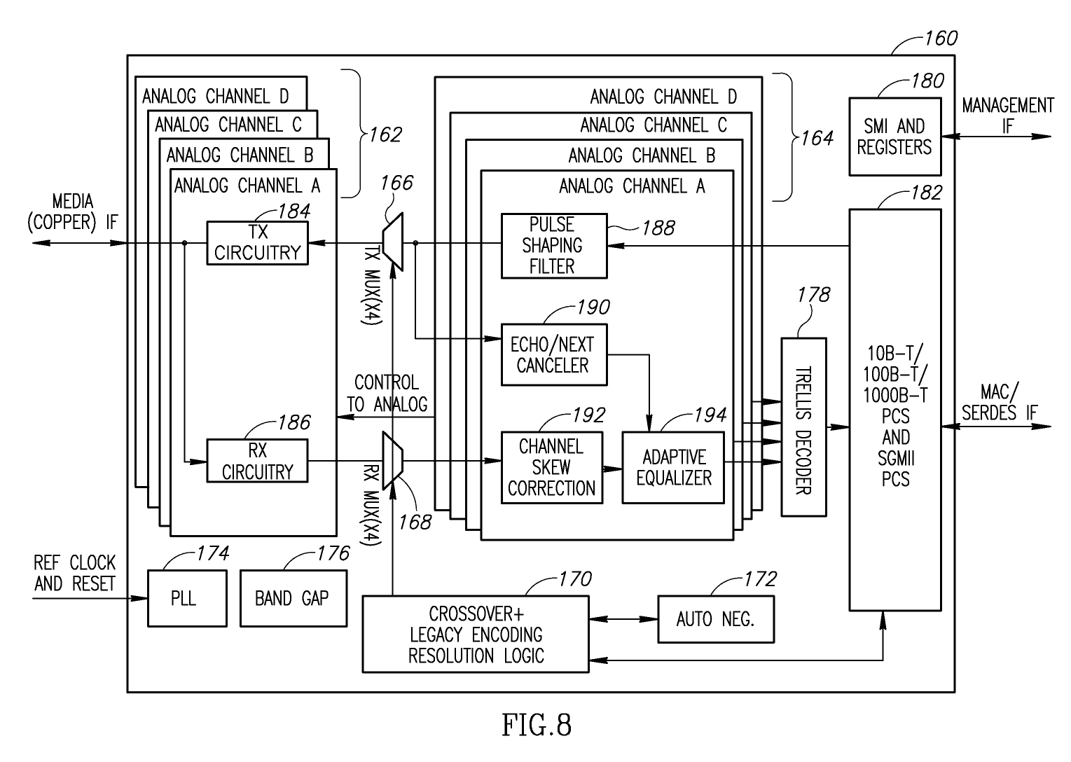

A block diagram illustrating an example communications transceiver incorporating the automatic cross and semi-cross cable resolution with multiple scrambling algorithms mechanism of the present invention is shown in FIG. 8. The gigabit Ethernet transceiver, generally referenced 160 comprises analog channels (i.e. A, B, C, D) 162, corresponding digital channels (i.e. A, B, C, D) 164, transmit multiplexers (one for each channel) 166, receive multiplexers (one for each channel) 168, phase lock loop (PLL) 174, band gap 176, crossover and legacy encoding resolution logic 170, autonegotiation logic 172, trellis decoder 178, structure of management information (SMI) and registers 180 and 10 Base-T/100Base-T/1000Base-T physical coding sublayer (PCS) and serial gigabit media independent interface (SGMII) PCS 182. Each analog channel 162 is further comprised of transmit (TX) circuitry 184 and receive (RX) circuitry 186. Each digital channel 164 is further comprised of pulse shaping filter 188, echo/next cancellers 190, channel skew correction 192 and adaptive equalizer 194.

In operation, crossover and legacy encoding control logic 170 controls multiplexers 166, 168 in the transmit and receive paths, thereby enabling crossover control and legacy encoding logic 170 to both resolve the different scrambling methods and switch incoming/outgoing data between channels A and B and between channels C and D according to the selected cross/semi-cross configuration. The interaction between crossover control logic 170 and auto-negotiation block 172 enables crossover control logic 170 to identify events such as an auto-negotiation restart after link establishment has failed (see the transitions in master mode in the state diagram of FIG. 4). In addition, when auto-negotiation starts there is a constant toggling between MDI to MDI-X (or in case we are in the master's ‘parallel path between MDI-CROSS CD and MDI-X-ALIGN CD) until we get an energy detection indication. The interaction between crossover and legacy encoding resolution logic 170 and PCS block 182 enables the de-scrambler (within the PCS) to indicate whether or not it has succeeded to lock onto the received data (i.e. successfully de-scrambled the data). The interaction between logic element 170 and PCS block 182 also initializes the scrambling mode to be used by both the scrambler and de-scrambler.

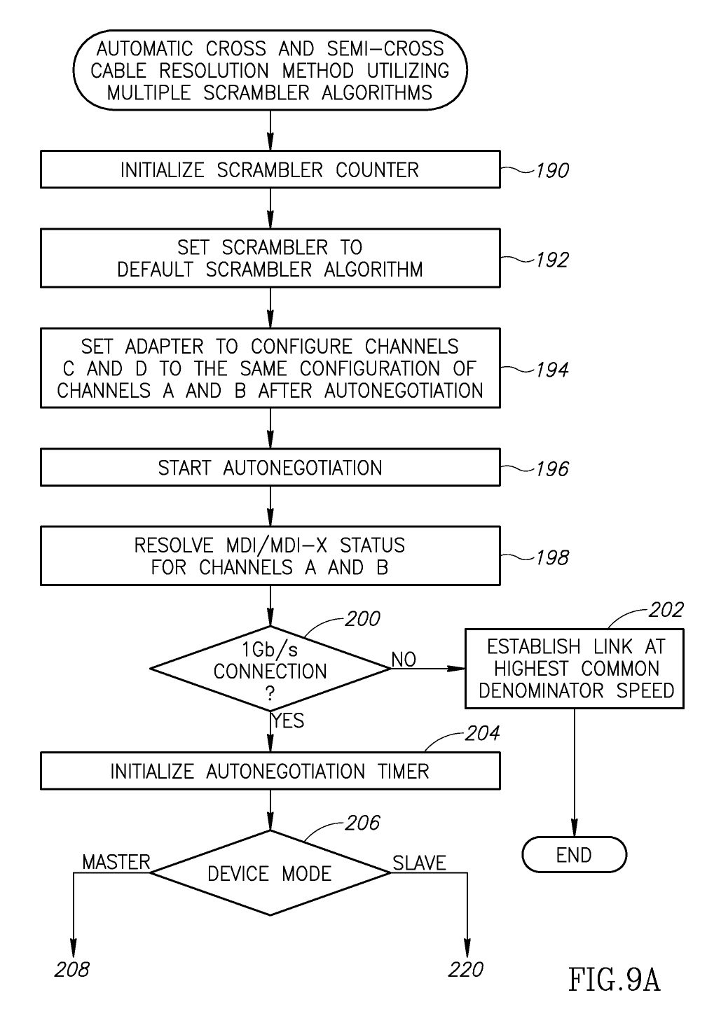

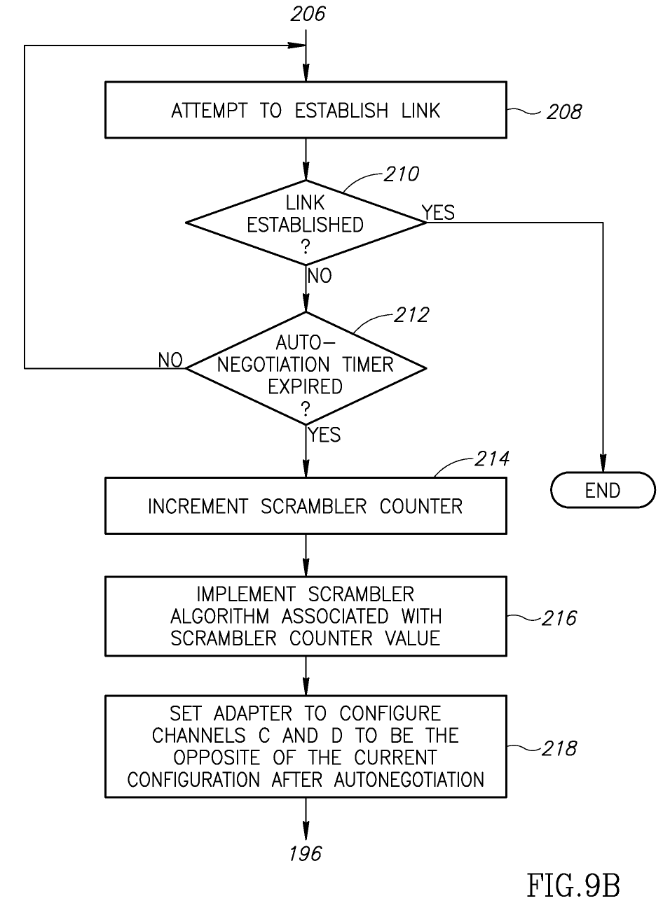

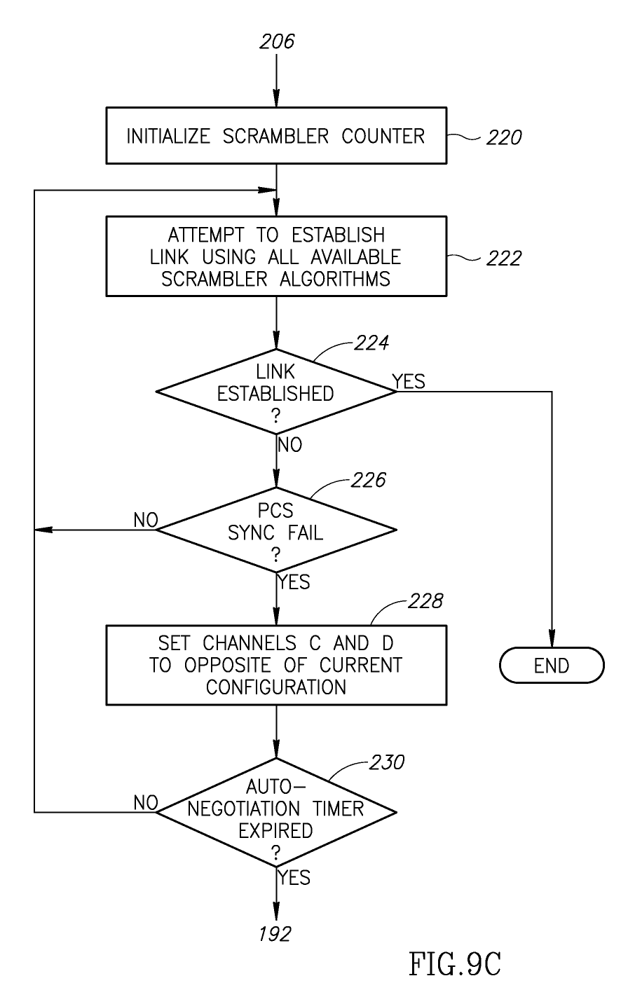

A flow diagram illustrating the automatic cross and semi-cross resolution with multiple scrambling method of the present invention is shown in FIGS. 9A, 9B and 9C. First, the scrambler counter is initialized (step 190) and the scrambler is set to the default scrambler algorithm (step 192). The adapter is then set to configure channels C and D to the same configuration as channels A and B after autonegotiation (step 194). If channels A and B are aligned (i.e. MDI) then C and D are aligned, or if channels A and B are crossed (i.e. MDI-X) then channels C and D are crossed.

Autonegotiation is started (196) and the MDI/MDI-X status (i.e., aligned or crossed) for channels A and B is resolved (step 198). If the connection with the link partner is not 1 Gb/s (step 200) then a link is established at the highest common speed between the device and the link partner (202). If the connection with the link partner is 1 Gb/s then the autonegotiation timer is initialized (step 204).

If the device is in master mode (step 206) then an attempt is made to establish a link (step 208). If a link is successfully established (step 210) then the method of the present invention has completed successfully. If the autonegotiation timer has not expired (step 212) then the method of the present invention returns to step 208 to attempt to establish a link.

If the autonegotiation timer has expired then link was not established, the scrambler counter is then incremented (step 214) and the scrambler implements the algorithm associated with the current value of the scrambler counter (step 216). The adapter is then set to configure channels C and D to be the opposite of their current relationship to channels A and B after autonegotiation (step 218). For example, if channels A, B, C and D are presently aligned then channels C and D will be crossed if channels A and B are aligned after the next autonegotiation. The method of the present invention then returns to step 196 to restart autonegotiation.

If the device is in slave mode (step 206) then the scrambler counter is initialized (step 220) and an attempt is made to establish a link using all available scrambler algorithms (step 222). If a link was established (step 224) then the method of the present invention has completed successfully. If a link was not established and there was no PCS Sync Fail event (step 226) then the method of the present invention returns to step 222 to attempt to establish a link. If there was a PCS Sync Fail event then channels C and D are set to the opposite of the current configuration (step 228). If channels C and D are presently aligned they will be crossed and if channels C and D are presently crossed they will be aligned. If the autonegotiation timer has not expired (step 230) then the method of the present invention returns to step 222 to attempt to establish a link (i.e. with the configurations of the device as set in step 228). If the autonegotiation timer has expired then the method of the present invention returns to step 192 to initialize the necessary settings to restart autonegotiation.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method to detect and resolve a semi-crossed cable linking an MDI/MDI-X networking adapter and its link partner, said method comprising the step of:
detecting link failures in both fully aligned and fully crossed states of said link; and
establishing a link with said link partner via said semi-crossed cable implementing a semi-crossed state.

2. The method according to claim 1, wherein upon completion of said step of establishing a link, said MDI/MDI-X networking adapter and its link partner are communicating at one gigabit per second.

3. The method according to claim 1, wherein said semi-crossed cable linking an MDI/MDI-X networking adapter and its link partner comprises channel A aligned with channel B and channel C crossed with channel D.

4. The method according to claim 1, wherein said semi-crossed cable linking an MDI/MDI-X networking adapter and its link partner comprises channel A crossed with channel B and channel C aligned with channel D.

5. The method according to claim 1, wherein said semi-crossed state of said MDI/MDI-X networking adapter comprises channel A aligned with channel B and channel C crossed with channel D.

6. The method according to claim 1, wherein said semi-crossed state of said MDI/MDI-X networking adapter comprises channel A crossed with channel B and channel C aligned with channel D.

7. The method according to claim 1, wherein said MDI/MDI-X networking adapter is in master mode.

8. The method according to claim 1, wherein said MDI/MDI-X networking adapter is in slave mode.

9. The method according to claim 1, further comprising determining a common scrambling method utilized by said MDI/MDI-X networking adapter and said link partner.

10. A method to detect and resolve a semi-crossed cable between an MDI/MDI-X networking adapter and its link partner, channels A and B of said MDI/MDI-X networking adapter operating in an aligned state and said adapter utilizing a scrambling method, said method comprising the steps of:
identifying the Ethernet PHY mode of said MDI/MDI-X networking adapter;
determining a common scrambling method utilized by said MDI/MDI-X networking adapter and said link partner; and
crossing channels C and D in response to a link failure thereby enabling said MDI/MDI-X networking adapter operating in MDI mode to successfully link to its link partner.

11. The method according to claim 10, wherein said MDI/MDI-X networking adapter is in master mode.

12. The method according to claim 10, wherein said MDI/MDI-X networking adapter is in slave mode.

13. The method according to claim 10, wherein said scrambling method utilizes a linear feedback shift register.

14. A method to detect and resolve a semi-crossed cable between an MDI/MDI-X networking adapter and its link partner, channels A and B of said MDI/MDI-X networking adapter operating in a crossed state and said adapter utilizing a scrambling method, said method comprising the steps of:
identifying the Ethernet PHY mode of said MDI/MDI-X networking adapter;
determining a common scrambling method utilized by said MDI/MDI-X networking adapter and its link partner; and
aligning channels C and D in response to a link failure, thereby enabling said MDI/MDI-X networking adapter operating in MDI-X state to successfully link to its link partner.

15. The method according to claim 14, wherein said MDI/MDI-X networking adapter is in master mode.

16. The method according to claim 14, wherein said MDI/MDI-X networking adapter is in slave mode.

17. The method according to claim 14, wherein said scrambling method utilizes a linear feedback shift register.

18. An MDI/MDI-X networking adapter capable of detecting and resolving a semi-crossed cable between said MDI/MDI-X networking adapter and its link partner, wherein channels A and B of said MDI/MDI-X networking adapter operating in an aligned state and with said adapter utilizing a scrambling method, said adapter comprising:
means for identifying the Ethernet PHY mode of said MDI/MDI-X networking adapter;
means for determining the common scrambling method utilized by said MDI/MDI-X networking adapter and said link partner; and
means for crossing channels C and D in response to a link failure thereby enabling said MDI/MDI-X networking adapter operating in MDI mode to successfully link to its link partner.

19. The adapter according to claim 18, wherein said MDI/MDI-X networking adapter is in master mode.

20. The adapter according to claim 18, wherein said MDI/MDI-X networking adapter is in slave mode.

21. The adapter according to claim 18, wherein said scrambling method utilizes a linear feedback shift register.

22. An MDI/MDI-X networking adapter capable of detecting and resolving semi-crossed cables between said MDI/MDI-X networking adapter and its link partner, wherein channels A and B of said MDI/MDI-X networking adapter operating in a crossed state and with said adapter utilizing a scrambling method, said adapter comprising:
means for identifying the Ethernet PHY mode of said MDI/MDI-X networking adapter;
means for determining the common scrambling method utilized by said MDI/MDI-X networking adapter and said link partner; and
means for aligning channels C and D in response to a link failure, thereby enabling said MDI/MDI-X networking adapter operating in MDI-X state to successfully link to its link partner.

23. The adapter according to claim 22, wherein said MDI/MDI-X networking adapter is in master mode.

24. The adapter according to claim 22, wherein said MDI/MDI-X networking adapter is in slave mode.

25. The adapter according to claim 22, wherein said scrambling method utilizes a linear feedback shift register.
